(19) United States
(12) Patent Application Publication
(10) Pub. No.: US 2006/0049950 A1
(43) Pub. Date: Mar. 9, 2006

(54) Fall-sensing systems, hip protector systems, and other protective systems

(76) Inventor: Thurman E. Lockhart, Blacksburg, VA (US)

Correspondence Address: WHITHAM, CURTIS & CHRISTOFFERSON, P.C., 11491 SUNSET HILLS ROAD, SUITE 340, RESTON, VA, 20190, US

(21) Appl. No.: 11/202,357

(22) Filed: Aug. 12, 2005

Related U.S. Application Data
(60) Provisional application No. 60/601,108, filed on Aug. 13, 2004.

(51) Int. Cl. G08B 23/00

(52) U.S. Cl. 340/573.1

(57) ABSTRACT

Fall-sensing systems are provided which do not generate false alarms for a non-falling event. Inventive fall-sensing systems may be magnetometer-free. Thin-profile (less than ½ inch, pre-inflation) wearable systems are provided. By removing the problem of false alarms and by slimming the pre-inflation profile, a practically useable wearable protection solution may be provided for an individual prone to falling. The number and severity of hip fractures in the elderly may be reduction. The inventive product actively assesses fall accidents and triggers an inflatable airbag protection device. The problem of non-compliance in wearing hip protectors that has previously limited the effectiveness of other hip protectors also has been solved.

### RELATED APPLICATION

This application claims benefit of U.S. provisional application No. 60/601,108 filed Aug. 13, 2004 titled “Hip inflatable protection bag (Hip-bag).”

### FIELD OF THE INVENTION

This invention relates especially to detection of and protective responses to falls by individuals, especially patients identified as prone to falling.

### BACKGROUND OF THE INVENTION

Each year in the United States alone, approximately 350,000 people suffer a hip fracture. One estimate suggests that, as the population ages, there will be nearly 650,000 hip fractures annually, or nearly 1,800 per day, by the year 2050. Only 25 percent of hip fracture patients make a full recovery; 40 percent require nursing home care; and 50 percent need a cane or walker. The cost of hip fractures averages $33,000 per patient and the mortality in the first six months following the fracture may be as high as 40%. Ninety percent of hip fractures are due to falls.

One way to reduce the incidence of hip fracture is for vulnerable patients to wear a protective pad around the hip to absorb the impact of a fall and/or redirect or “shunt” the impact energy away from the hip region. These devices, known as external hip protectors, are usually made with plastic shields that are padded or constructed with hard plastic shields or soft foam pads that fit into specially designed pockets in undergarments or pants.

There is biomechanical and clinical evidence that external hip protectors are effective in reducing the risk of hip fracture in the event of a fall. They may also enhance confidence and mobility in older people. The effectiveness of a hip protection system depends, however, on user compliance in wearing the device. In general, compliance is low due to obtrusiveness and cumbersomeness of current hip pad designs. While conventional, available hip protectors are relatively effective at preventing fractures when worn correctly, these devices do not meet consumer needs for comfort and aesthetic appeal. Until the acceptability of hip protector devices is improved, seniors at risk of injury will not be as willing to use these devices and the incidence of hip fracture will remain high.

Many attempts have been made, conventionally, to address this significant problem, including attempts to use airbag technology to improve compliance and reduce impact injuries such as hip fractures.

However, currently there are no commercially available personal protective devices using airbag technology in the United States market (as well as the world) to reduce hip impact injuries (or bodily injuries) due to falls. Viable inflatable personal protection devices has been lacking. Conventionally, an effective fall-sensing algorithm has yet to be provided. Also, problems exist with false-alarms for non-falling events.

Further problems exist because, when a fall actually is occurring, conventional triggering mechanism approaches cannot inflate the airbags fast enough to provide effective protection. Moreover, conventional systems are too bulky in their pre-inflation state to be acceptably sized to consumers.

The following are mentioned by way of background: U.S. Patent Application Nos. 20050067816 and 20040183283. Also: U.S. 20010049840 A1, U.S. Pat. No. 6,433,691 B1, U.S. Pat. No. 6,270,386 B1, U.S. Pat. No. 6,032,299, U.S. Pat. No. 6,021,519, U.S. Pat. No. 5,867,842, U.S. Pat. No. 5,500,952, U.S. Pat. No. 5,402,535, U.S. Pat. No. 4,977,623, U.S. 20020083513 A1, U.S. Pat. No. 6,450,943 B1, U.S. Pat. No. 6,139,050, U.S. Pat. No. 6,039,347, U.S. Pat. No. 6,012,162, U.S. Pat. No. 5,937,443, U.S. Pat. No. 5,896,590, U.S. Pat. No. 5,749,059 U.S. Pat. No. 5,086,514, U.S. Pat. No. 4,825,469, U.S. Pat. No. 4,637,074, U.S. Pat. No. 4,059,852, U.S. Pat. No. 3,972,526, U.S. Pat. No. 3,921,944, U.S. Pat. No. 3,085,248, U.S. Pat. No. 2,803,015, U.S. Pat. No. 2,118,196, U.S. Pat. No. 1,532,037, U.S. Pat. No. 1,042,327, WO 9852433 A1, WO 9851170 A1, WO 9716084, WO 9101658 A1, WO 3020586 A1, JP 2002331041, JP 2002317315, JP 2000027010, JP 11350213 A, JP 11335911 A, JP 11036109 A, JP 10310919 A, GB 2223395, FR 2802778 A3, FR 2802060 A1, FR 2778067 A1, EP 825368 A1, EP 743021, EP 1005800 A1, DE 4405074 A1, DE 198338022 C1, DE 19820228 A1, DE 19744808 A1, DE 10053436 A1, U.S. Pat. No. 05,545,128, U.S. Pat. No. 05,599,290.

An energy shunting padding system is described in J Biomechanical Eng., 117:409-413 (1995).

### BRIEF SUMMARY OF THE DRAWINGS

FIG. 1 is an acceleration profile (Z) during normal seating, for pelvis (A2 sensor) for downward acceleration.

FIG. 2 is an acceleration profile (Z) during stooping to grab an item from the floor, for pelvis (A2 sensor) downward acceleration.

FIGS. 3, 4, 5 are acceleration profiles (x, y, z) of raw (FIG. 3), filtered (FIG. 4) and transformed (FIG. 5) data during normal walking.

FIGS. 6, 7, 8 are acceleration profiles (raw (FIG. 6), filtered (FIG. 7) and transformed (FIG. 8)) of slips and falls.

FIGS. 9, 10 are graphs of angle history of a slip and fall accident (FIG. 9) and normal walk (FIG. 10), showing transformed angles.

FIG. 11 depicts a flow chart of an exemplary inventive trigger mechanism for an inventive inflatable protection device. Steps 1, 2, 3 show sequence of operation.

FIG. 12 depicts an exemplary alternative inventive embodiment which is a hollow needle assembly to reduce size.

FIG. 13 shows a hip airbag system including manifold, airbag assembly and inlayed tubing system and air vent system. FIG. 13 is not drawn to scale.

FIG. 13A shows a hip airbag system with one continuous tubing inlay, and an air vent system. FIG. 13 is not drawn to scale.

FIG. 14 is a block diagram of an exemplary inventive fall-sensing system.

### SUMMARY OF THE INVENTION

Advantageously, inventive automatic fall-sensing systems are provided which may be configured so that a false alarm for a non-falling event is not generated. Also advantageously, inventive fall-sensing systems may be magnetometer-free. The inventive fall-sensing technology may be included in applications with a triggering mechanism, to automatically inflate airbag-type systems that protect one or more body parts of a wearer who is prone to fall. Airbag technology that is suitable for a wearable application in which a falling individual is to be protected is provided herein. Thus, the present inventor has solved problems associated with conventional hip protectors worn by human patients and provided automatically-inflating hip protection systems.

The invention in a preferred embodiment provides a fall-sensing system for automatically detecting when an individual is falling, comprising: computer-based testing of actual patterns of motion of the individual against two or more permitted patterns of motion, including automated testing for presence or absence of a first permitted pattern of motion based on determination of whether an expected peak of acceleration (such as linear acceleration and/or angular acceleration) according to the first permitted pattern is detected or not detected.

In inventive fall-sensing systems, one or more of the following optional features may be included. When an expected peak of acceleration (such as linear acceleration and/or angular acceleration) according to the first permitted pattern is not detected, then automated testing may be performed for presence or absence of at least one second permitted pattern of motion (such as automated testing when the first permitted pattern of motion is a walking pattern (such as a walking pattern with expected peaks of acceleration occurring at 400-450 milliseconds), and the automated testing makes a determination of whether an expected peak of acceleration is occurring or is failing to occur).

In another preferred embodiment, the invention provides a fall-sensing system for automatically detecting when an individual is falling, comprising: computer-based testing of actual patterns of motion of the individual against one or more permitted patterns of motion, wherein the computer-based testing is applied to computer-readable data derived from measured acceleration but is not raw acceleration data.

Examples of computer-based operations used in the inventive fall-sensing systems are, e.g., a computer-based comparison made using other than absolute value of acceleration measured for actual motion of the individual; computer-based transformation of raw acceleration data measured for the individual into transformed acceleration data; computer-based testing of the transformed acceleration data against the one or more permitted patterns of motion; a computer-based transformation that comprises a geometrical transformation; computer-based testing that comprises a first computer-based operation in which a comparison is made against a permitted activity pattern (such as, e.g., a permitted walking pattern) and actual motion is determined to be outside the permitted activity pattern, followed by a second computer-based operation in which a comparison is made against a second permitted pattern; computer-based comparison of measured motion against a normal defined range of peaks of acceleration of less than 5 m/sec² downward acceleration, followed by at least one subsequent computer-based comparison; etc.

In another preferred embodiment, the invention provides a protection system comprising: an inventive fall-sensing system and a solution system (such as, e.g., a hip protection system; a solution system that prevents the fall; a solution system that activates stimulation of at least one muscle of a wearer; etc.) activated when the fall-sensing system senses a fall, such as, e.g., a protection system wherein the solution system ameliorates the fall by preventing impact injury to a wearer; a protection system including a solution system that prevents the fall (such as, e.g., an up-thrust parachute solution system; etc.); a protection system including a device powered by bio-electricity; a protection system including a sensor embedded in a muscle of a person to be protected by the protection system, wherein the muscle generates power for a device powered by bio-electricity; etc.

The invention in a further preferred embodiment provides a wearable protection system comprising a fall-sensing system that automatically detects when a wearer is falling and at least one protective component that is automatically deployed before completion of a fall, wherein the protective component comprises a manifold design. An example of a protective component is, e.g., a protective component that has at least two inflatable compartments configured to inflate simultaneously via an inlayed tubing system when automatically triggered.

The invention in another preferred embodiment provides a wearable body-part protection system comprising: at least one inflatable protective component positioned that, when inflated, the inflated protective component is adjacent to a body part being protected and provides a protective barrier extending beyond the protected body part; a fall sensing system (such as, e.g., a fall sensing system that comprises at least one of an accelerometer and a gyroscope and excludes a magnetometer; an inventive fall sensing system herein; a fall-sensing system that includes computer-based comparison of measured motion against a normal defined range of peaks of acceleration of less than 5 m/sec² downward acceleration, followed by at least one subsequent computer-based comparison; and other fall-sensing systems; etc.) that automatically detects whether the wearer is falling without generating a false-alarm for non-falling motion; a triggering mechanism (such as, e.g., a triggering mechanism that comprises a puncturable gas-containing canister that releases a gas into the inflatable protective component; a triggering mechanism that automatically inflates the inflatable protective component when the fall sensing system measures backwards rotation exceeding zero degrees; etc.) that (i) through an electrical connection receives data from the fall sensing system and (ii) controls inflation of the at least one inflatable protective component (such as, e.g., inflation control by including a manifold with a hose or an inlaid tube system), wherein the inflatable protective component automatically inflates before a falling wearer reaches the ground and wherein the triggering mechanism is set to automatically inflate the inflatable protective component upon predetermined data from the fall sensing system. Preferably the inflatable protective component may be inflated all-at-once rather than inflated by gradual filling. An example of an inventive protection system is, e.g., a protective system comprising firmware, inertial sensors and at least one puncturable canister filled with gas releasable into the at least one inflatable protective component.

In the inventive protection systems, preferably when downward acceleration exceeds 8 m/sec², at least one subsequent computer-based comparison is performed before any triggering mechanism is triggered. Most preferably, when downward acceleration exceeds 8 m/sec², sufficient subsequent computer-based comparisons are performed before any triggering mechanism is triggered to avoid a false alarm for a non-falling activity.

The inventive fall-sensing systems and protection systems may be wearable by an individual. For wearable protection systems, a thin profile is preferred, such as, e.g., a total pre-inflation profile of all components of the wearable system before being inflated of less than about ½ inch.

### DETAILED DESCRIPTION OF a PREFERRED EMBODIMENT OF THE INVENTION

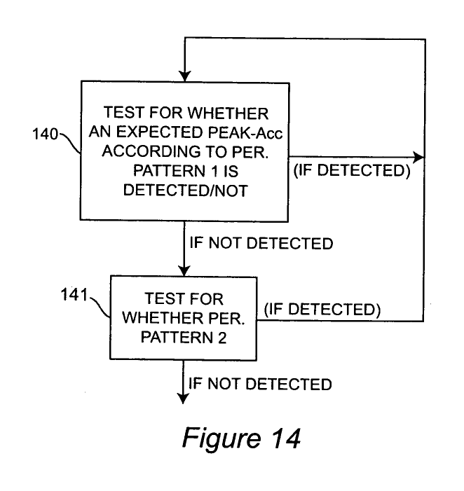

A preferred embodiment of an inventive fall-sensing system may be appreciated with reference to FIG. 14. When a fall sensing system such as that of FIG. 14 is to be used for protecting a walking individual who is undergoing a fall, it will be appreciated that steps 140, 141 must be automatic (or computer-based) to occur in a timely manner. A testing operation 140 is repeatedly performed, repeated at short enough time intervals to be able to provide a meaningful response if a fall is in fact beginning. Test operation 140 tests for whether an expected peak of acceleration according to a first permitted pattern is detected or not detected. If an expected peak of acceleration according to a first permitted pattern (such as a walking pattern) is detected within time (such as about 400 to 450 milliseconds), then the test operation 140 is repeated in due time. In test operation 140 what is being tested against the expected peak of acceleration is data derived from actual movement of a individual (such as, preferably, an individual wearing the fall-sensing system in a garment-like form).

If test operation 140 returns a result that an expected peak of acceleration according to a first permitted pattern is not detected, then the operation proceeds immediately to test 141 for whether a second permitted pattern is occurring. That is, the inventive fall-sensing system refrains from immediately concluding whether a fall is occurring based only on the non-occurrence of a first permitted pattern. For example, an individual may be stooping, and thus it would be undesirable for a false-alarm to be “declared” when the individual is not walking but is only stooping. By requiring at least two test operations 140, 141, the inventive fall-sensing system minimizes the occurrence of false alarms. If the test 141 detects occurrence of a permitted pattern, then the system returns to testing 140 and refrains from initiating activity associated with a fall.

A permitted pattern means a motion pattern stored in memory (such as in a chip) via calibration of a particular individual's motion pattern. A permitted pattern may include but is not limited to walking, stooping, sitting, reaching, running, etc. Preferably, writeable memory is used, the fall-sensing system is programmable and the fall-sensing system may be individualized.

Preferably, a learning mode may be used to calibrate the fall-sensing system, because not every individual's peak occurs at the exact point in time as other individuals. When a learning mode is used, initially, an individual may wear the device including the fall-sensing system and move (such as walking around, etc.), after which the data from that initial session is saved and used for permitted pattern(s) in subsequent wearing of the device. (Optionally, during an initial session, an individual wearing the fall-sensing system may be induced to fall while wearing a safety harness, to obtain data for a falling pattern specific for that individual. A falling pattern may then be stored in memory as a “non-permitted pattern,” and in subsequent usage actual motion of an individual wearing the fall-sensing system may be automatically tested against a non-permitted pattern.)

Referring again to FIG. 14, if test 141 does not detect the second permitted pattern, optionally in one embodiment, the system may exit the fall-sensing operations and proceed to automatically initiate protective action. Alternately, in another embodiment, one or more others test for one or more other permitted pattern may be performed before the fall-sensing operations are exited and there is automatically initiated protective action and/or fall-stopping action.

An inventive fall-sensing system according to FIG. 14 may be used in an inventive protective system which comprises the fall-sensing system and further comprises an automatically-inflatable component that when a fall is sensed by the fall-sensing system is inflated in a timely manner (i.e., before completion of the fall to impact). In a particularly preferred embodiment, an inventive protection system is wearable. Examples of a wearable protection system include, e.g., an automatically-inflatable vest, an automatically-inflatable hip-protector, an automatically-inflatable head-protector, an automatically-inflatable back-protector, an automatically-inflatable elbow protector, winter coat, etc.

Examples of individuals to be protected by an inventive wearable protection system include, e.g., a patient prone to falling (such as a patient with a history of one or more falls); a patient recovering from a fall, an injury, etc.; an athlete or a sporting enthusiast; a workman working in a line of work prone to falls; etc. An inventive wearable protection system is constructed taking into account the nature of falls associated with the activity or activities during which the wearable protection system is to be worn, the permitted patterns of movements, the individual to be protected, the body part(s) to be protected, etc.

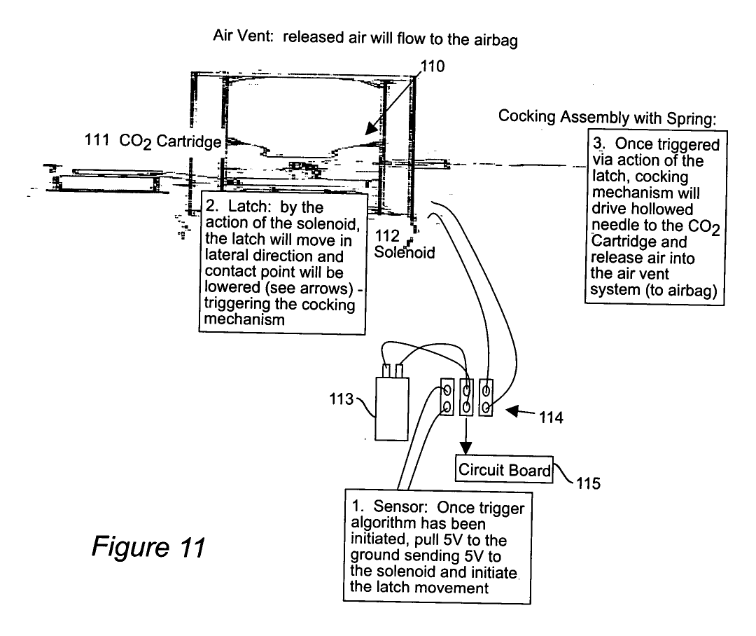

In a preferred example of an inventive wearable protection system, a fall sensing system and a triggering mechanism are included. The fall sensing system uses inertial (accelerometers and gyroscopes) sensors to detect a fall event during walking or performing daily activities. The triggering mechanism uses a solenoid (such as solenoid 112 in FIG. 11) and puncturing mechanism to actively release air (CO₂) into the airbags.

The inventive fall-sensing systems perform computer-based comparisons of actual motion of a to-be-protected individual against one or more permitted patterns of motion. Examples of a permitted pattern of motion in the inventive fall-sensing systems, are, e.g., a permitted walking pattern, a permitted pattern in which whole body center of mass is lowered (such as a stooping pattern, a sitting pattern, etc.), a permitted pattern associated with performing a sport, etc.

Although a profile of an inventive wearable protective system is not required to be a thin profile, advantageously a thin profile (such as, e.g., less than about ½ inch) can be provided.

When an inventive protective system uses a thin profile (such as, e.g., a pre-inflation profile of less than about ½ inch), an example of an inflated profile may be, e.g., about 2 to 6 inches, preferably about 2 to 4 inches. By slimming the pre-inflation profile, combined with the reduction or event the avoidance of generation of false alarms (such as, e.g., by avoiding use of a magnetometer; conducting computer-based comparison of actual motion against more than just an absolute acceleration value; conducting computer-based comparison against a series of permitted movement patterns; etc.), the invention may be used to provide a wearable protection solution for an individual prone to falling that the individual will find to be unobtrusive and discrete.

In some inventive embodiments, a fall that has begun and is underway is interrupted by changing the falling action of the individual.

However, in other embodiments, a fall that has begun proceeds (i.e., the falling individual continues to fall), and the invention provides protection to a to-be-protected individual who falls. That is, the wearer falls, but some of the impact energy of the fall (that the individual would have received if he were not wearing the wearable inventive protection system) is instead received by something other than the wearer, namely, by the protection system. In such embodiments, preferably, an inventive protection system includes an air vent system to release air (i.e., the air that had been inflated into the inflatable protection component) as the wearer contacts the ground. The air vent system provides smoothness and also advantageously helps to muffle high frequency noise that otherwise would be associated with release of energy upon impact.

Inventive protective systems may be used to actively sense a fall, may be non-obtrusive, may have better pressure attenuation and correspondingly may be safer than conventional hip protection technology. The invention is particularly useable in rehabilitation settings. For example, a patient rehabilitating may wear an inventive device and walk freely without harnesses and rails.

The invention is particularly useful to apply to hip protection. Advantages of the present invention in the hip protection application may include, when referring to individual patients and/or to populations, one or more of: increased compliance of wearing hip protectors, increased energy absorption, and reduction of fall-related hip fractures.

### EXAMPLE 1

### Hip Inflatable Protection Bag

The product of this Example 1 will reduce the number and severity of hip fractures in the elderly. The product acts to reduce the risk of hip fractures from falls in elderly patients. The design solves the problem of non-compliance that has previously limited the effectiveness of conventional hip protection devices.

Most hip fractures are related to direct trauma to the hip. Energy absorption rather than bone strength has been suggested to be the main determinant of hip fractures. In order to increase energy absorption and to shunt impact forces, external hip protector pads have been developed. External hip protector pads have been shown to reduce the incidence of hip fractures in individuals living in residential homes and nursing homes by nearly 50%, despite compliance rates of 24%. Thus, protection of the greater trochanter appears essential in order to prevent the development of hip fracture. Laboratory experiments have also shown it is possible to avoid impact to the greater trochanter with the hip protector.

An objective of this inventive Example 1 is to have increased compliance of wearing hip protectors. In addition, the invention provides increased energy absorption and thereby reduces the risk of hip fractures. A fall is actively sensed. A device of this Example is smaller, non-intrusive, and provides better pressure attenuation compared to conventional devices, which means it is safer and will result in less hip fractures.

Conventional hip protector technology using soft and hard shell hip pads offer some reduction in the peak impact forces, but energy shunting systems such as airbag systems may be superior to absorbing peak impact forces to prevent hip fractures. The external hip protector of this inventive Example 1 redirects the impact energy away from the greater trochanter during falls from standing heights. At impact, the hip protector transmits released energy to the soft tissue and surrounding muscles. Conventional hip protection devices are made of inflexible hard plastic plates worn in pockets on the sides of undergarments. However, inflexible hard plastic plates may not be able to redirect the impact energy fully to the surrounding tissues of an elderly faller due to the inadequate and insufficient amount of tissue present on the hip and leg of the elderly. The inventive inflatable hip inflatable protection bag will effectively shunt impact energy to the greater trochanter by evenly distributing released energy to the surrounding areas such as skin and soft tissues using air bag technology (i.e., increasing the contact areas by forming with the contact body) insuring that no bone is directly impacted by the surface upon which the wearer has fallen.

Better compliant hip protective systems may play a vital role in the prevention of hip fractures among the elderly. In most of the studies on conventional hip protectors, compliance has been the biggest problem. Average compliance rates ranged from 24% to 45%. Major reasons for not wearing the conventional hip protectors were: readily conspicuous; too unattractive; and too bulky and cumbersome to wear. Even though more than 90% of all hip fractures theoretically may be preventable when systematic intervention programs for nursing homes are initiated, prevention of hip fractures among home dwellers may be a greater challenge—indicating the importance of having a compliance-friendly wearable hip protection system. The inflatable hip bag design (along the lines of elastic shorts) is a solution to obtrusiveness and cumbersomeness of wearing a hip pad.

The bag of this Example 1 actively senses an individual's fall prior to hitting the ground and deploys an airbag around the individual's hip in order to cushion the fall and reduce the risk of hip fractures. The bag includes at least: the sensor package; the gas generator; and the airbag cushion.

The sensor package may consist of 3D accelerometers and gyroscopes to assess six degrees of freedom movement patterns. The combination of the acceleration and angular rate sensors allow for fall sensing.

In this Example 1, the gas generator consists of a fast acting valve and a small pressurized canister of carbon dioxide. The valve receives the signal from the logic board and releases the pressurized gas. There may be used a pressurized canister such as commonly used for toy BB guns and readily available at a sporting goods store. Replacement cartridges thus may be available and low cost. The bag of this Example 1 thus is re-usable simply by replacing the cartridge and pressing a reset button on the logic board. Sodium azide propellant may be used to augment the gas generation needed to fill the bag.

The airbag cushion preferably is minimally obtrusive. The airbag is designed with elastic as a tight but flexible undergarment. In the non-deployed state, the airbag system resembles a pair of shorts and the actual airbag part covers an area of approximately 14 inches by 8 inches on the left and right hip. Once triggered, the gas canister will fill the airbag to a thickness of about 3 to 4 inches (preferably about 3 inches). An advantage of this design is that the airbag is already in position and only needs to expand about 3 to 4 inches outward, thereby eliminating the potential for injury from the airbag itself. In other words, the airbag is already covering the hip and only needs to fill with gas, and does not need to deploy outward as in the case of an automobile airbag.

For this Example 1, the deployment event lasts for 25 milliseconds (ms). This times includes 10 ms for the sensor package to detect the fall, 5 ms for the valve to respond to the sensor trigger signal, and 10 ms for the airbag cushion to inflate. Once deployed, the airbag remains inflated for 2000 ms (or 2 seconds) in order to provide the padding during the floor impact. This timeframe is within the design guidelines of commercial automobile airbag systems.

### EXAMPLE 2

Fall Sensing System

In any ambulatory/moving activities such as walking, our body experiences gravitational pull from the earth, and in order to propel our body, we induce force against the ground (ground reaction force—GRF) using our musculoskeletal system. Given the constant mass, acceleration changes in all three axes.

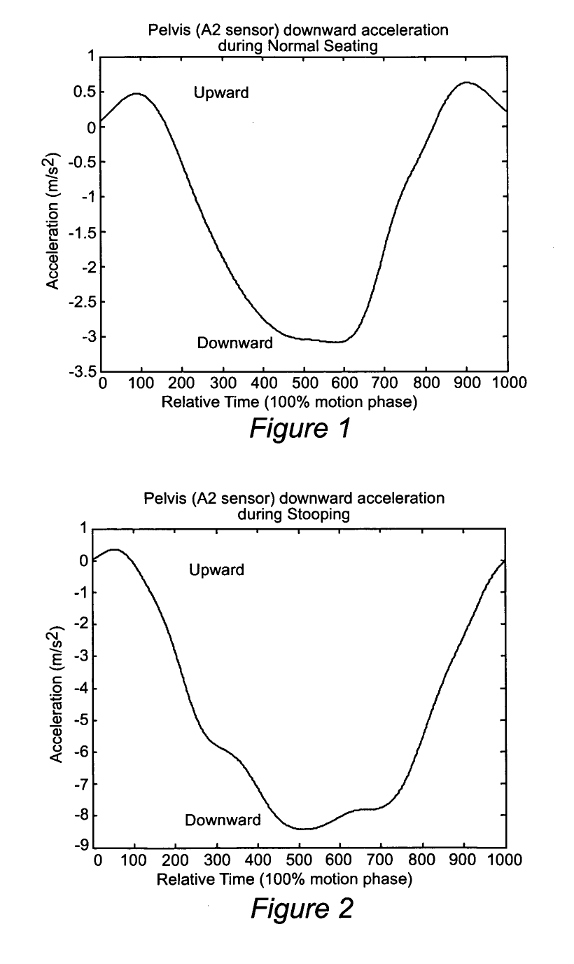

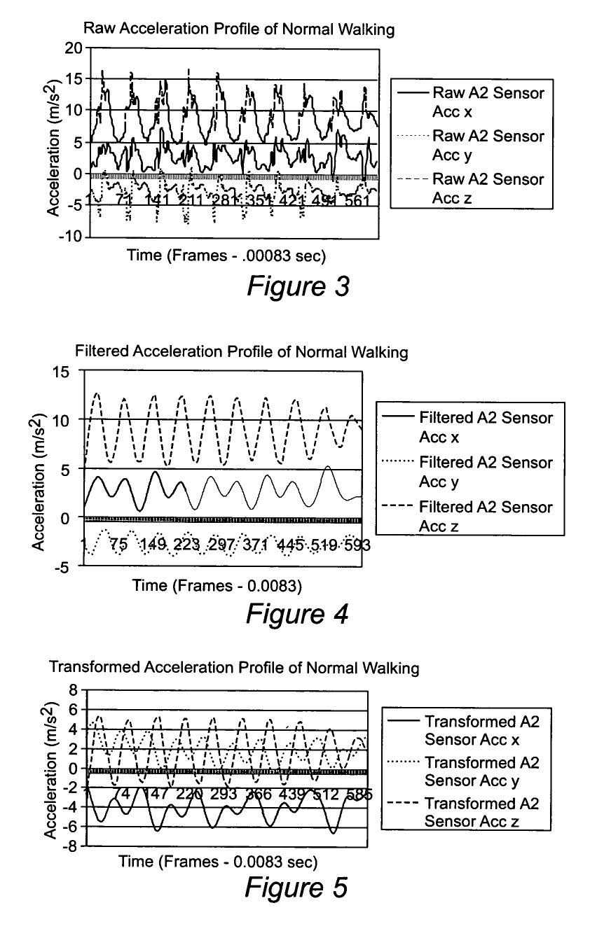

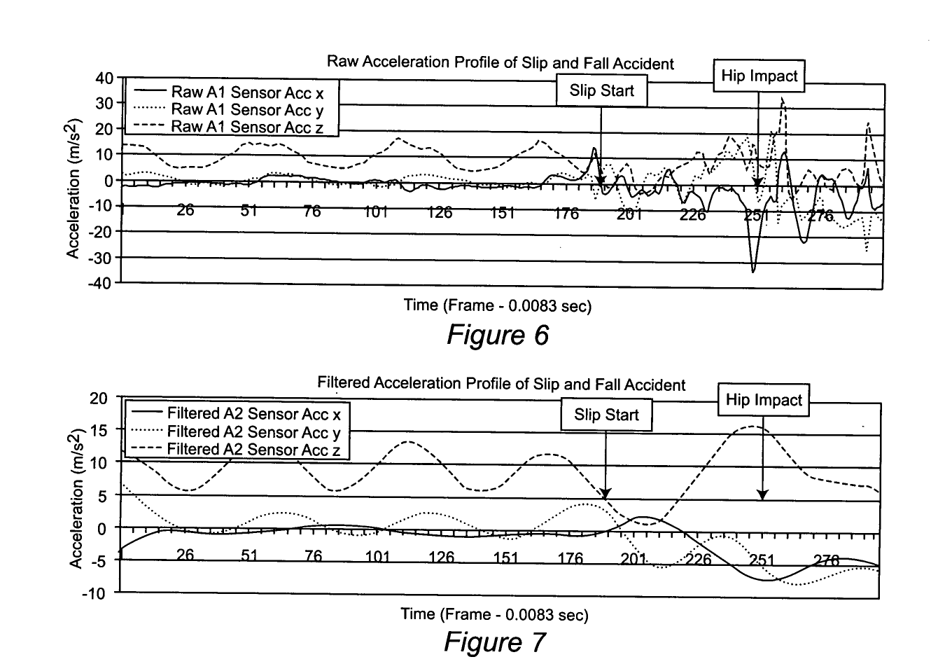

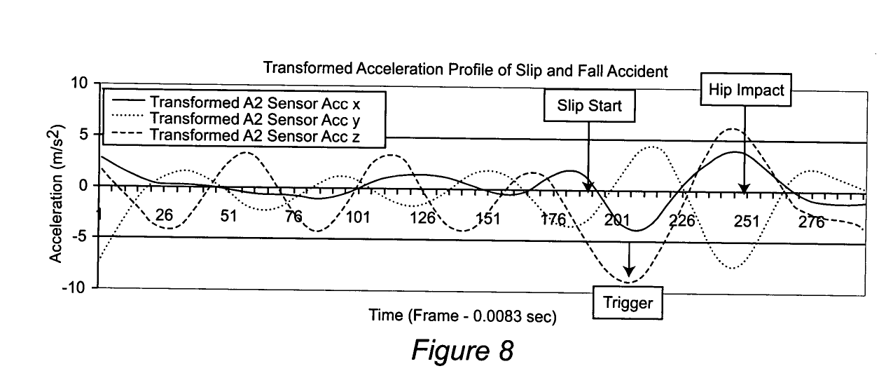

Acceleration profile (accelerations in all three planes—X—side to side, Y—forward and backward, and Z—up and down) associated with different activities such as walking, seating, and stooping can be distinguished using inertial sensors. Examples of such acceleration profiles of different activities are illustrated in FIGS. 1 and 2. During normal seating and stooping, acceleration (z) can reach up to 8 m/sec². Similarly, acceleration profiles during normal walking are illustrated in FIGS. 3, 4, and 5. Acceleration in a raw (FIG. 3) form is assessed directly from the device; afterwards, these raw data are filtered (using filtering algorithm—low pass filter was used for this data) and transformed to derive an algorithm (using plane of reference criteria). These processes ensure that a given raw signal will correctly interpret motion characteristics—such as a fall. FIGS. 6, 7 and 8 illustrate the acceleration profiles of slip and fall accident. Again these data were filtered and transformed. Acceleration peak occurs at approximately 450 ms to 520 ms for normal walking activity.

A fall accident can be differentiated from other activities by using information from kinematic motion characteristic experiments. For example, a fall accident is sensed using the following criteria:
(1) Prior to trigger, peaks of acceleration should be within 450 ms to 520 ms during normal ambulation (not for running—which will be shorter) at less than 5 m/s² downward acceleration (transformed data). (However, if raw data (instead of transformed data) is used, a relative value may be used (e.g., 50% of trigger value).)
(2) If condition one is met and downward acceleration exceeds 8 m/s², then trigger.
(3) If condition one is not met and downward acceleration exceeds 8 m/s²—such as stooping, trigger should not activate.

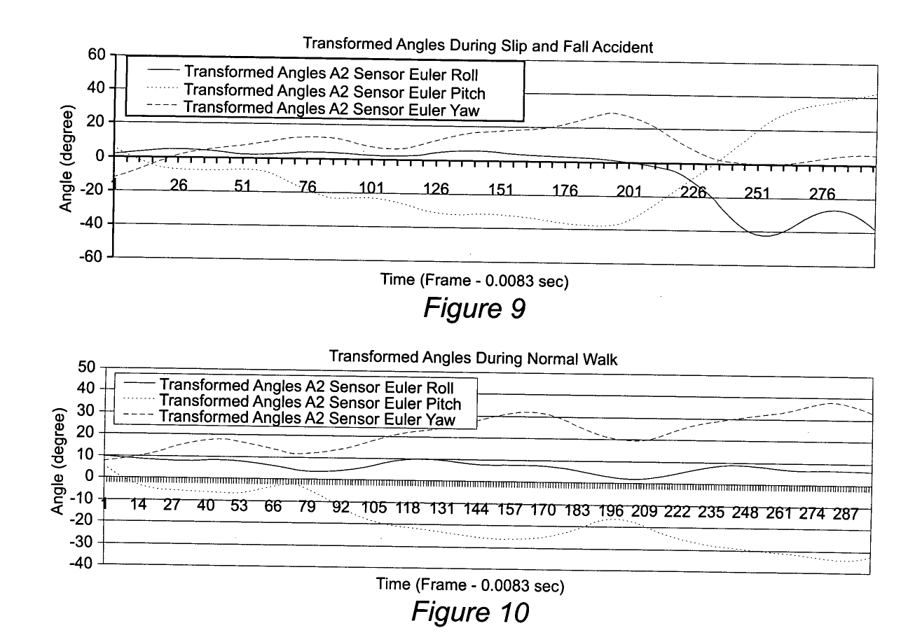

Furthermore, angle data (especially x—roll—in FIGS. 9 and 10) for roll (forward and backward) can be used for triggering. During normal walking x-axis angle does not extend lower than 0°. During slips and falls, backward rotation exceeds 0°. Thus, angle information can be used in conjunction with acceleration data to trigger a determination that a fall is occurring.

Angle information can also be used for transforming the acceleration profiles from local to global coordinates.

A system according to above criteria (1)-(3), optionally including the further criteria regarding angle data above, may be embedded in a firmware with inertial sensors to produce state change or a pulse to trigger a solenoid.

Trigger Mechanism

The triggering mechanism of this Example 2 uses a solenoid and puncturing mechanism to actively release air (CO₂) into the airbags. Firmware developed to send/generate a pulse (or state change) to the solenoid will activate the trigger mechanism. Voltage in this example is not fixed to 5 V. 2.5 V may be used to trigger. The sequence of operation is illustrated in FIG. 11, step 1 thru 3.

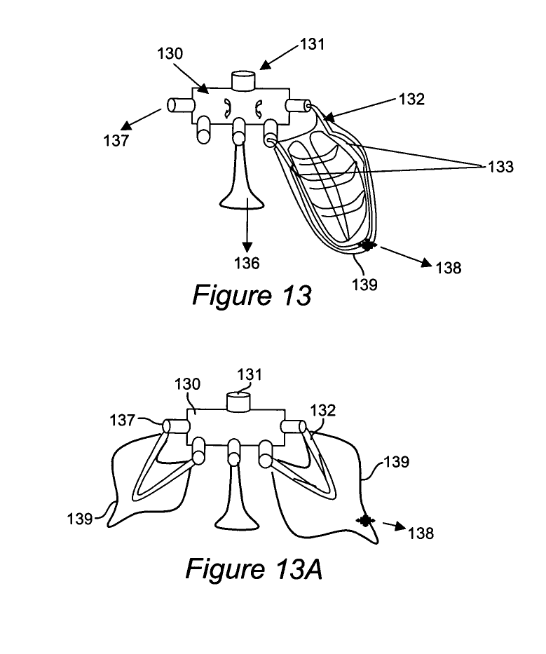

Referring to FIG. 11, a hollow needle assembly 110 is used. An air (preferably CO₂) cartridge 111 is used. Air from the cartridge 111 is used to inflate the airbag. Released air flows via the air vent (such as air vent 138 in FIGS. 13, 13A).

In FIG. 11, power is provided by a power source 113 such as a battery (such as a 9V battery, a lithium-type battery, etc.). Connectors 114 are connected respectively to the solenoid 112, the circuit board 115 and the power source (e.g., battery) 113.

Use of the embodiment of FIG. 11 may proceed as follows. A first “sensor” step is as follows: Once a trigger algorithm has been initiated, 5V is pulled to the ground, sending 5V to the solenoid 112 and initiating latch movement.

A second “latch” step is as follows: by the action of the solenoid 112, the latch moves in a lateral direction and a contact point is lowered triggering the cocking mechanism.

A third “cocking” step is as follows: Once triggered via action of the latch, the cocking mechanism (such as a cocking assembly with a spring) drives the hollowed needle 110 to the cartridge 111 and air is released into the air vent system (to the airbag).

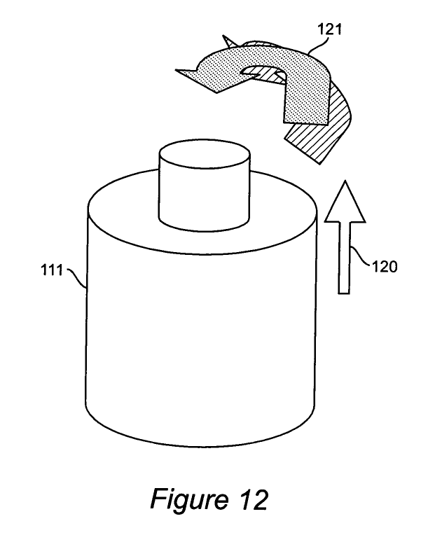

A more compact configuration may use a stiffer spring thereby reducing the cocking assembly distance. Furthermore, the hollow needle assembly 110 may be configured such that size of this device is no larger than the air cartridge 111 (FIG. 12). In FIG. 12, arrow 120 shows movement associated with the solenoid and arrows 121 show a puncturing system (e.g., a hollow needle assembly) and movement of that system driving into the cartridge 111 to release the air.

Hip Airbag System

The hip airbag of this Example is composed of airbag material (such as, e.g., plastic, closely knitted fabric) enclosed in a specific shape to cover the hip and back region of an individual. The airbag is connected via a plastic tubing interlay in the hip airbag for even-immediate-dispersion of air to both hip regions simultaneously. Air vents are incorporated in the hip airbag to release air to surroundings when/during impact—to cushion the impact smoothly and without reflecting mass (i.e., no bouncing effect). Air vents also work to muffle the sound of the airbag system—to the low frequency component. The inlay-tubing assembly is attached to a manifold design as shown in FIG. 13. Upon triggering and release of air (gas)—air source will travel into the manifold and distributed to each tubing attachments—and ultimately to the airbags via inlay tubing assembly.

FIGS. 13 and 13A show air manifold 130 through which air (such as CO₂ from an air canister) travels. Air enters the air manifold 130 through air source input terminal 131.

In FIG. 13, inlay tubing 132 (such as plastic inlay tubing) is shown, inside of the airbag 139. Sliced tubing 133 is used for releasing air into the airbag 139.

FIG. 13A is an alternative inventive embodiment, in which each airbag 139 uses only one continuous tubing inlay 132.

In FIGS. 13 and 13A, air is output via tubing attachments 137. Air exits from the inflated airbag 139 via air vent system 138. Coccyx protector 136 is shown.

Referring to FIG. 13 and FIG. 13A, it will be appreciated that the manifold has been shown drawn overly large and in actual size is small. In actual size, the bags are bigger than shown in FIG. 13 or FIG. 13A.

### EXAMPLE 3

### Bio-Electricity

Optionally, in an alternative embodiment, bio-electricity may be used for powering a device included in an inventive wearable protection system. For example, one or more sensors may be embedded in one or more muscles of a person to be protected. The muscles themselves generate power for operating a device.

While the invention has been described in terms of its preferred embodiments, those skilled in the art will recognize that the invention can be practiced with modification within the spirit and scope of the appended claims.

What I claim as my invention is:

1. A fall-sensing system for automatically detecting when an individual is falling, comprising: computer-based testing of actual patterns of motion of the individual against two or more permitted patterns of motion, including automated testing for presence or absence of a first permitted pattern of motion based on determination of whether an expected peak of acceleration according to the first permitted pattern is detected or not detected.

2. The fall-sensing system of claim 1, wherein when an expected peak of acceleration according to the first permitted pattern is not detected, then automated testing is performed for presence or absence of at least one second permitted pattern of motion.

3. The fall-sensing system of claim 1, wherein the first permitted pattern of motion is a walking pattern with expected peaks of acceleration occurring at 400-450 milliseconds and the automated testing makes a determination of whether an expected peak of acceleration is occurring or is failing to occur.

4. The fall-sensing system of claim 1, wherein the permitted patterns of motion include a permitted walking pattern and at least one other permitted pattern in which whole body center of mass is lowered.

5. The fall-sensing system of claim 4, wherein the at least one other permitted pattern in which whole body center of mass is lowered is selected from the group consisting of:
a stooping pattern and a sitting pattern.

6. A fall-sensing system for automatically detecting when an individual is falling, comprising: computer-based testing of actual patterns of motion of the individual against one or more permitted patterns of motion, wherein the computer-based testing is applied to computer-readable data derived from measured acceleration but is not raw acceleration data.

7. The fall-sensing system of claim 6, wherein the one or more permitted patterns of motion include a permitted pattern associated with performing a sport.

8. The fall-sensing system of claim 6, wherein a false alarm for a non-falling event is not generated.

9. The fall-sensing system of claim 6, wherein the computer-based comparison is made using other than absolute value of acceleration measured for actual motion of the individual.

10. The fall-sensing system of claim 6, including computer-based transformation of raw acceleration data measured for the individual into transformed acceleration data and wherein the computer-based testing is of the transformed acceleration data against the one or more permitted patterns of motion.

11. The fall-sensing system of claim 10, wherein the computer-based transformation comprises a geometrical transformation.

12. The fall-sensing system of claim 6, wherein the system is magnetometer-free.

13. The fall-sensing system of claim 6, wherein the computer-based testing comprises a first computer-based operation in which a comparison is made against a permitted activity pattern and actual motion is determined to be outside the permitted activity pattern, followed by a second computer-based operation in which a comparison is made against a second permitted pattern.

14. The fall-sensing system of claim 13, wherein the permitted activity pattern under comparison in the first computer-based operation is a permitted walking pattern.

15. The fall-sensing system of claim 6, wherein the system is wearable by the individual.

16. A protection system comprising: a fall-sensing system and a solution system activated when the fall-sensing system senses a fall.

17. The protection system of claim 16, wherein the solution system ameliorates the fall by preventing impact injury to a wearer.

18. The protection system of claim 16, wherein the solution system is a hip protection system.

19. The protection system of claim 16, wherein the solution system prevents the fall.

20. The protection system of claim 16, wherein the solution system activates stimulation of at least one muscle of a wearer.

21. The protection system of claim 16, wherein the solution system is an up-thrust parachute.

22. The protection system of claim 16, including powering a device by bio-electricity.

23. The protection system of claim 16, wherein a sensor is embedded in a muscle of a person to be protected by the protection system, and the muscle is used to generate power for a device powered by bio-electricity.

24. A wearable protection system comprising a fall-sensing system that automatically detects when a wearer is falling and at least one protective component that is automatically deployed before completion of a fall, wherein the protective component comprises a manifold design.

25. The protection system of claim 24, wherein the protective component has at least two inflatable compartments configured to inflate simultaneously via an inlayed tubing system when automatically triggered.

26. A wearable body-part protection system comprising:
at least one inflatable protective component positioned that, when inflated, the inflated protective component is adjacent to a body part being protected and provides a protective barrier extending beyond the protected body part;
a fall sensing system that automatically detects whether the wearer is falling without generating a false-alarm for non-falling motion;
a triggering mechanism that (i) through an electrical connection receives data from the fall sensing system and (ii) controls inflation of the at least one inflatable protective component, wherein the inflatable protective component automatically inflates before a falling wearer reaches the ground and wherein the triggering mechanism is set to automatically inflate the inflatable protective component upon predetermined data from the fall sensing system.

27. The protection system of claim 26, wherein inflation control includes a manifold with a hose or an inlaid tube system.

28. The protection system of claim 26, wherein the inflatable protective component is inflated all-at-once rather than inflated by gradual filling, further including an air vent system to release air as the wearer contacts the ground.

29. The protection system of claim 26, wherein the fall sensing system comprises at least one of an accelerometer and a gyroscope and excludes a magnetometer.

30. The protection system of claim 26, wherein the triggering mechanism comprises a puncturable gas-containing canister that releases a gas into the inflatable protective component.

31. The protection system of claim 26, wherein the fall-sensing system includes computer-based comparison of measured motion against a normal defined range of peaks of acceleration of less than 5 m/sec² downward acceleration, followed by at least one subsequent computer-based comparison.

32. The protection system of claim 31, wherein when downward acceleration exceeds 8 m/sec², the at least one subsequent computer-based comparison is performed before any triggering mechanism is triggered.

33. The protection system of claim 26, wherein the triggering mechanism automatically inflates the inflatable protective component when the fall sensing system measures backwards rotation exceeding zero degrees.

34. The protection system of claim 26, comprising firmware, inertial sensors and at least one puncturable canister filled with gas releasable into the at least one inflatable protective component.

35. The protection system of claim 26 wherein a total pre-inflation profile of all components of the wearable system before being inflated is less than about ½ inch.
